(19) United States
(12) Patent Application Publication
(10) Pub. No.: US 2001/0010486 A1
(43) Pub. Date: Aug. 2, 2001

(54) Method of forming a seamless solenoid plunger wear band

(75) Inventor: Stephen M. Schmidt, Menomonee Falls, WI (US)

Correspondence Address: Ryan Kromholz & Manion, S.C., P.O. Box 26618, Milwaukee, WI, 53226-0618, US

(73) Assignee: Trombetta, LLC

(21) Appl. No.: 09/812,208

(22) Filed: Mar. 19, 2001

Related U.S. Application Data
(62) Division of application No. 09/461,788, filed on Dec. 15, 1999.

(51) Int. Cl. H01F 7/08

(52) U.S. Cl. 335/220

(57) ABSTRACT

An apparatus and method for forming and applying seamless wear bands to a cylinder, such as a solenoid plunger. The apparatus consists principally of an expanding diameter pushing tool and mating conical mandrel. The pushing tool contacts and moves a flat washer type disc along the sides of the mandrel. As the disc travels along the mandrel it is transformed into a band configuration and snapped into a pre-formed undercut groove on the cylinder.

### BACKGROUND OF THE INVENTION

The present invention relates to solenoid plunger wear bands and, in particular, a method of forming and applying seamless wear bands to a solenoid plunger.

In the past, methods of forming long cycle life bearing surfaces have been costly. Some past practices have included the use of press fit bushings, plunger coatings, and ground and polished surfaces. Bands made from wear resistant products such as virgin TEFLON or etched RULON sheets have also been used.

Presently, strip-type bands have been know to encounter problems in installation. The strips are typically formed by hand from sheet stock material and are assembled into the plunger tube while simultaneously being located in machined grooves in the plunger. Assembly of strip-type wear bands is time consuming due to the difficulty of holding a close overall length dimension of the strip. This is because the roll of sheet stock does not lie flat while going through the die. Consequently, a secondary, labor intensive trimming operation must be added. Additionally, the seam created at the point where the strip ends meet is susceptible to ripping if one end comes out of the groove.

Alternatively wear bands can be molded with a gap to allow stretching over a plunger, these require costly tooling and once tooled, are rather inflexible. The present invention and method provides a seamless wear band that requires less material and is more labor efficient than the above-noted bands and methods. For example, hand forming of the bands during assembly is no longer required. Further, the plunger assembly can be removed from the plunger tube, and reassembled with minimal possibility of losing the band, as was common in earlier methods. The seamless nature of bands formed and installed according to this disclosure alleviates these problems.

Further, the present invention provides the efficiency and economy necessary to work with standard sized solenoid components such as tubes and plungers.

### SUMMARY OF THE INVENTION

The present invention provides a novel method for forming and installing seamless wear bands for use on cylindrical objects in need of this type of protection. It is intended primarily for use on solenoid plungers, although it is to be understood that any cylindrical object requiring wear resistant bands may utilize the method disclosed herein.

The invention includes a flat washer or apertured disc made of bearing material, such as Garlock Multi-fil 426. The apertured disc may be stamped from a sheet of material, or pre-formed in any of a variety of methods, including molding. This washer or disc is ultimately formed into a band and installed on a cylindrical object, such as a solenoid plunger. The use of a washer configuration eliminates the troublesome seam that is a feature of prior art wear bands. The change in shape, from a flat washer to a seamless band, is possible due to the cold flow and stretching properties of the material used and the assembly process that permanently snaps the seamless band onto the cylinder.

The process whereby the washer is transformed to a band and snapped onto a cylinder includes mating an end of a forming mandrel to one end of the cylinder to receive the resultant band. The mating end of the mandrel is of a diameter equal to the cylinder end, while the diameter of the opposite end of the mandrel is equal to the inner diameter of the washer to be formed. The washer is placed on the opposite end of the mandrel and an expanding diameter tool comes down on the washer, sliding the washer down the mandrel. A lubricant, such as WD-40 may be used to facilitate the downward movement. When the now transforming washer is at the transition between the mandrel and the cylinder end, it is assuming a band shape. As the downward movement continues, the band snaps into a pre-formed groove in the cylinder. Accordingly, since the tube and cylinder to be banded are of pre-determined diameters, the size of the groove to receive the band can be readily determined. The process is completed after the cylinder is pressed through a sizing mandrel in the opposite direction to the band just assembled. The present design lends itself well due to the equivalence in volumes of the pre-formed apertured disc and that of the resultant wear band. It should be apparent that the volume of the disc to be formed remains constant throughout its transformation. If additional bands are needed on the cylinder, the process in completed for each required band.

### DESCRIPTION OF THE DRAWINGS

FIG. 1 is a partially exploded view of a solenoid plunger in mating relationship with a truncated, conical mandrel and a washer to be formed into a seamless wear band, and their relationship to the expanding diameter pushing tool.

FIG. 2 is a longitudinal cross sectional view of the expanding diameter pushing tool and taken along lines 2-2 of FIG. 1.

FIG. 3 is an exploded view of the expanding diameter pushing tool, used in the assembly of a seamless wear band in a pre-formed solenoid plunger having a pre-formed undercut groove for receiving a wear band.

FIG. 4 is a side plan view of a truncated, conical mandrel used in locating the wear band within the undercut groove in the solenoid plunger of FIG. 1.

FIG. 4a is a top plan view of the mandrel illustrated in FIG. 4.

FIG. 4b is a longitudinal section view of the mandrel illustrated in FIG. 4, and taken along lines 4b-4b of FIG. 4a.

FIG. 5 is an alternate embodiment of the mandrel similar to the mandrel shown in FIG. 4.

FIG. 5a is an alternate embodiment expanding diameter pushing tool for use in manual formation and installation of a seamless wear band to cylinder.

FIG. 6 is a perspective view of a pre-formed washer-like disc to be formed into a seamless wear band and for depositing in the aforementioned groove in the solenoid plunger.

FIG. 6a is a top plan view of the disc shown in FIG. 6.

FIG. 6b is a diametrical cross section view of the disc shown in FIG. 6.

FIG. 7 is a top plan view of a seamless wear band as formed on a solenoid plunger.

FIG. 7a is a diametrical cross section view of the band shown in FIG. 7

FIG. 8 is a side elevational view, partly in cross section, of the expanding diameter pushing tool in the at rest position, and a solenoid plunger arranged to receive its encircling wear band.

FIG. 9 is a side elevational view, partly in cross section of the tool shown in FIG. 8 but in with the disc being partially deformed in readiness for its axial movement towards its receiving groove, and in initial contact with a plurality of radially disposed pushing elements.

FIG. 10 is a side elevational view, partly in cross section of the tool shown in FIG. 8 but in an intermediate step wherein the pushing elements continue in their movement to stretch and form the wear band as it travels towards its final position.

FIG. 11 is a side elevational view, partly in cross section, of the tool shown in FIG. 8, but with the wear band snapped into final position in the groove on the solenoid plunger.

FIG. 12 is a side elevational view, partly in cross section, of the hollow sizing sleeve having a portion of its length ground to a relatively polished surface, and in readiness to receive a solenoid plunger having a wear band installed in its groove.

FIG. 12a is a cross sectional view, partly in cross section, of the sizing sleeve shown in FIG. 12 but showing the plunger and its band being pressed through the precision sizing area.

FIG. 13 is a side elevational view, partly in cross section of the sleeve shown in FIG. 12 and showing the solenoid plunger in its final position relative to the sizing sleeve.

FIG. 14 is side elevational view of a finished solenoid plunger including a pair of seamless wear bands after installation and sizing.

### DETAILED DESCRIPTION

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

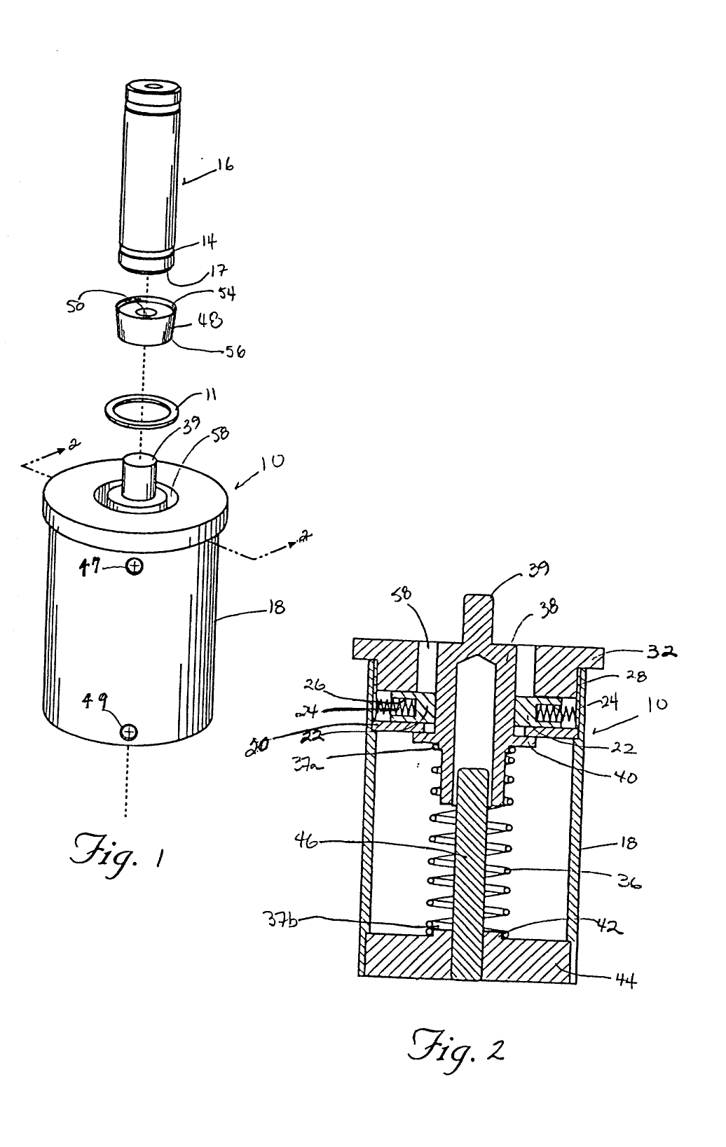

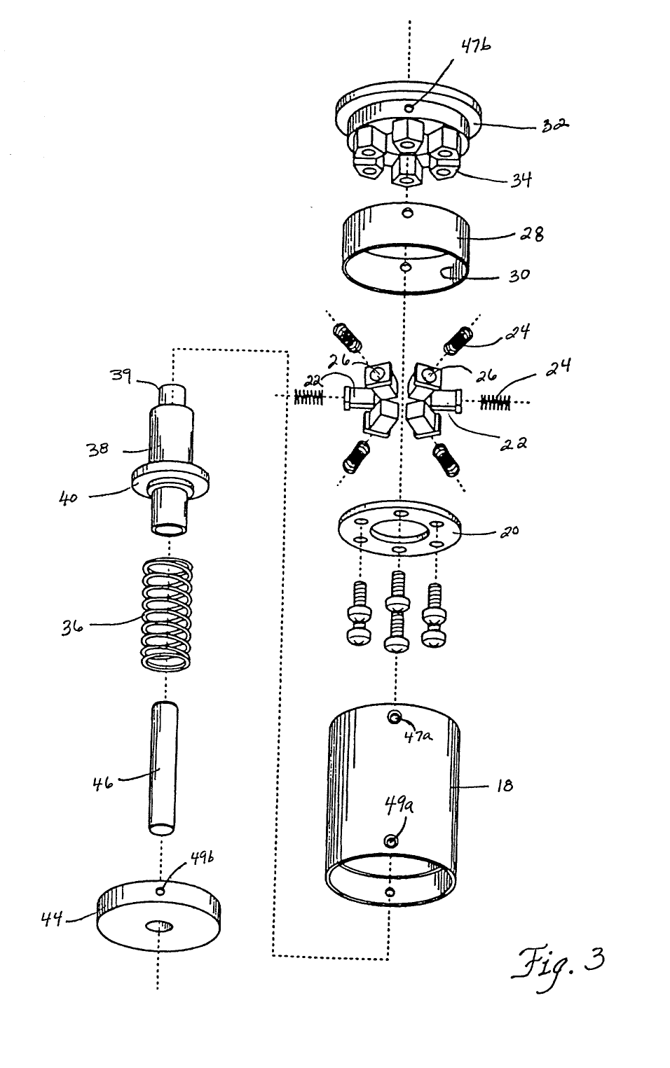

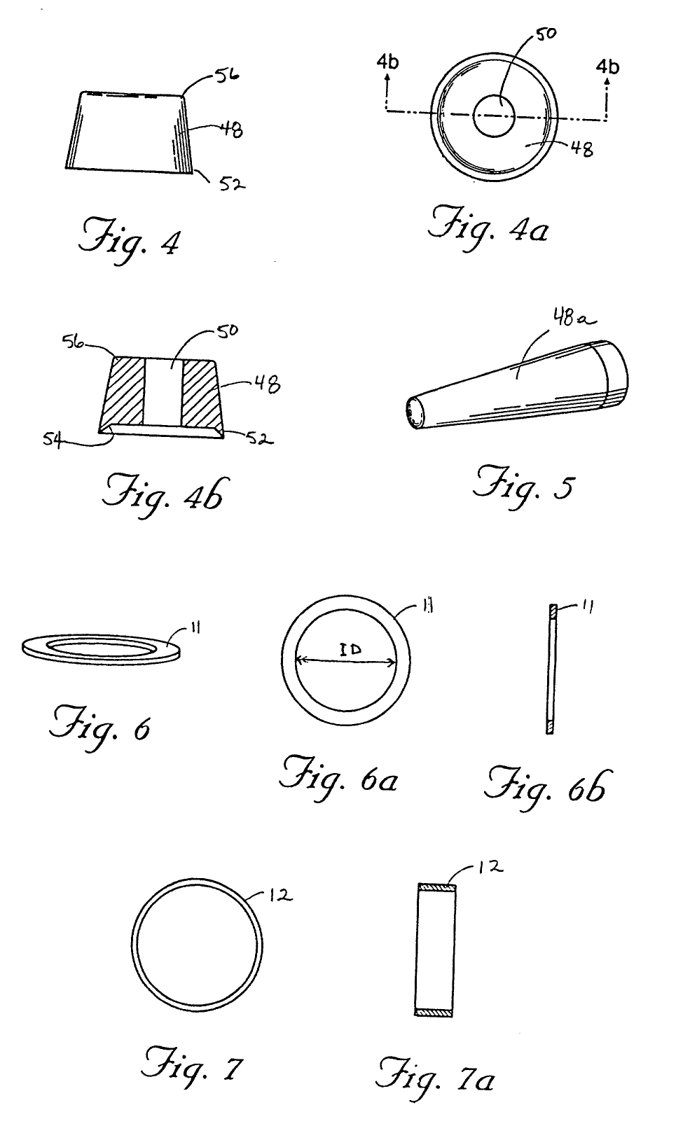

With reference to the drawings, and in particular to the views of FIGS. 1-3, the novel apparatus in the form of an expanding diameter pushing tool 10 is shown. The expanding diameter pushing tool, or apparatus, 10 is used to form and install seamless wear bands 12 onto a pre-formed, undercut, groove 14 on a cylinder, such as a conventional cylindrical solenoid plunger 16. The expanding diameter pushing tool 10 comprises, in general, a housing 18, a washer 20, a plurality of finger pushers 22 that are radially biased for longitudinal movement by coil springs 24 seated within the bore 26 of a respective pusher 22. A spring capturing ring 28 includes an inner surface 30 abutting against the opposite end of a respective spring 24. An end piece 32 includes dividers 34 for circumferentially spacing and receiving the finger pushers 22. The expanding diameter pushing tool 10 is further provided with means for manual longitudinal movement thereof. As seen in FIG. 2, a longitudinally extending spring 36 is mounted on a return core 38. One end 37a of the longitudinally extending spring 36 abuts a radially extending flange portion 40 of the return core 38, while the opposite end 37b of the spring 36 rests on a raised stationary spring retainer portion 42 of the base member 44. The end piece 32 and base member 44 are each attached to opposite ends of the housing 18 by means of mounting screws 47 and 49, respectively. The threaded screws 47 and 49 are respectively received by the apertures 47a and 49a of the housing 18, and are seated in threaded bores 47b and 49b of the end piece 32 and the base member 44. The spring 36 provides upward bias of the return core 38, as shown in the view of FIG. 2. A stabilizing rod 46 runs through the center of the spring 36 and provides axial stability for the spring 36. The expanding diameter pushing tool 10 receives a truncated conical mandrel 48 as seen with respect to FIGS. 4, 4a, and 4b. The mandrel 48 includes a bore 50 for receiving an upstanding pin 39 of the return core 38 (See FIGS. 1 and 2), and further includes a distended end portion 52 having an undercut chamfered radial area 54, and a constricted end 56. The undercut area 54 is dimensioned to seat the mandrel 48 on an end of the solenoid plunger 16 to be fitted with the wear band 12, to be later described.

An alternate embodiment mandrel 48a is seen in FIG. 5. The alternate mandrel 48a is somewhat more elongated than the preferred truncated mandrel 48 shown in FIG. 4, but may be used to manually install seamless wear bands 12 on a cylindrical object such as a solenoid plunger 16. The alternate mandrel 48a is to be used with an alternate embodiment pusher tool 10a (seen in FIG. 5a). Both mandrels 48, 48a serve similar purposes.

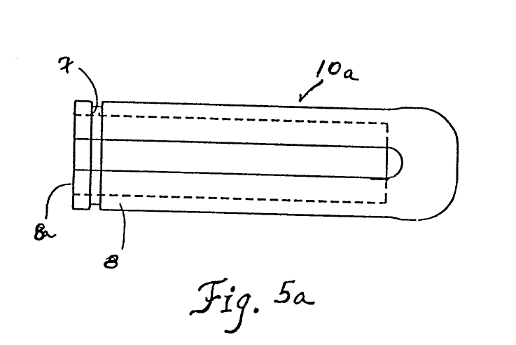

Referring now to FIGS. 6-7a, a pre-formed, apertured disc 11 and resultant wear band 12 are shown. The apertured discs 11 are pre-formed from a material such as Garlock Muli-fil 426. The apertured discs 11 may be manufactured in a variety of manners including, stamping, molding, or cutting into the desired configuration. Although other material may be used, only material having requisite properties will perform satisfactorily. For example, the material must stretch during assembly into the retaining groove 14 in the solenoid plunger 16 and then partially return to its original shape. Further, once the material is in the retaining groove 14 it must flow at room temperature as it is forced through the final sizing tool 60. Once the band 12 has been sized, the material needs to remain dimensionally stable at the operating temperature of the cylinder on which it is installed and should not change dimensions while under normal loading over time or when exposed to chemical compounds typically found in the application environment.

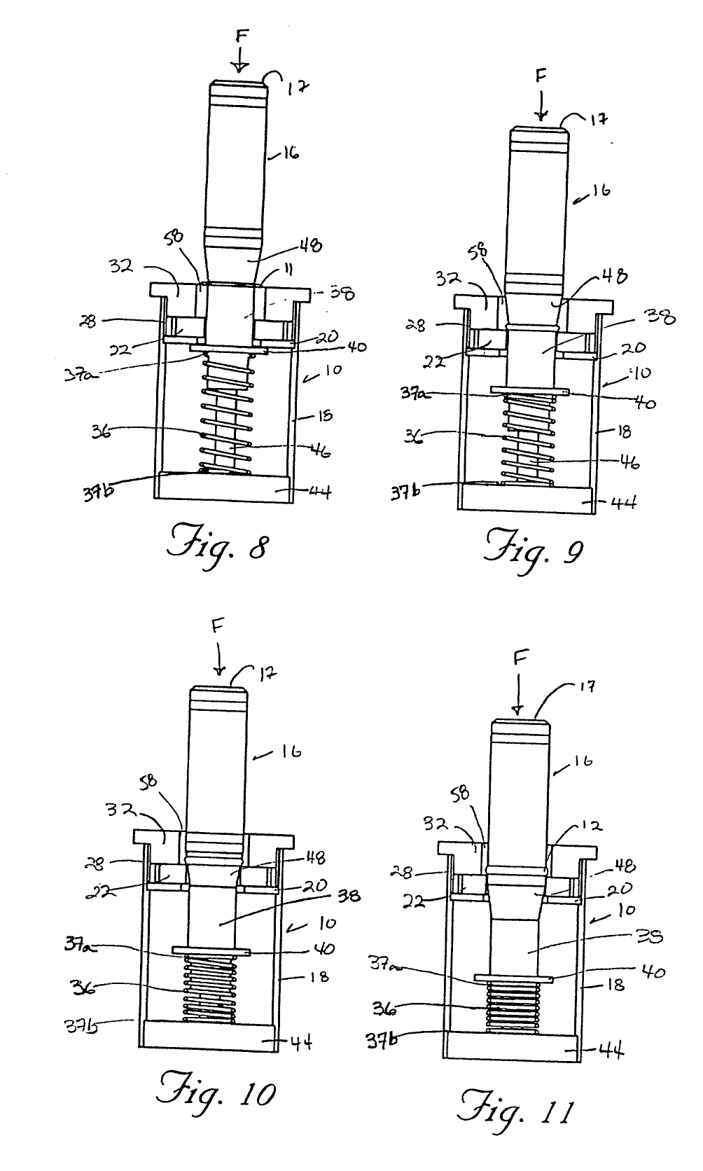

The various stages of accomplishing the procedure and operation of this invention are best described with reference to the views of FIGS. 8-14, inclusive. In the present procedure, the apparatus and method are used to form and install a seamless wear band 12 on a pre-formed groove 14 in a solenoid plunger 16. The preferred band is transformed from the aforementioned apertured disc-like configuration shown in FIGS. 6, 6a, and 6b to the band-like configuration of FIGS. 7 and 7a, and sized to a height approximately the longitudinal length of its groove 14 and a thickness slightly greater than the depth of groove 14. The resultant band 12 will have an outer diameter slightly smaller than the inner diameter of the tube (not shown) in which the plunger 16 will slide.

The view of FIG. 8 shows the expanding diameter pushing tool 10 in the at-rest position with the cylindrical object, such as a solenoid plunger 16 adapted to receive the wear band 12 (seen as an apertured disc 11 in this view) and resting on the truncated conical mandrel 48. The mandrel 48 includes a constricted end portion 56 and a distended end portion 52. The constricted end portion 56 is positioned to be in contact with the inner diameter of the apertured disc 11 to be formed, while the distended end portion 52 is mated with one end 17 of the solenoid plunger 16. In this view, the apertured disc 11 is shown resting on the return core 38. A downward force F is shown by means of an arrow, and is applied by means of any conventional type of press (not shown) common to manufacturing, such as an arbor press. The press (not shown) rests against the exposed end 17 of the solenoid plunger 16. In an alternate embodiment, the downward force F may be supplied manually, in which case an alternate embodiment mandrel and pushing tool such as that previously shown and discussed with reference to FIGS. 5 and 5a, may be used.

Referring next to the view of FIG. 9, it will be noted that the spring 36 has begun compression. As the spring 36 compresses, the solenoid plunger 16 and its mated mandrel 48 move with the apertured disc 11 into the expanding diameter pushing tool cavity 58 (detailed in FIG. 2). This movement forces the inner diameter (seen as ID in FIG. 6a) of the apertured disc 11 to make initial contact with the finger pushers 22. Continued downward movement of the solenoid plunger 16 further compresses the spring 36, as seen in FIG. 10, such that the individually spring biased finger pushers 22 force the inner diameter ID of the now deforming apertured disc 11 over the conical surface of the mandrel 48 and along its sides. As this movement occurs, the apertured disc 11 begins to take a band form. The spring 36 allows compression to a maximum point that is equal to the distance the solenoid plunger 16 or other cylindrical object and mated mandrel 48 must travel to ensure proper band 12 seating within the pre-formed groove 14.

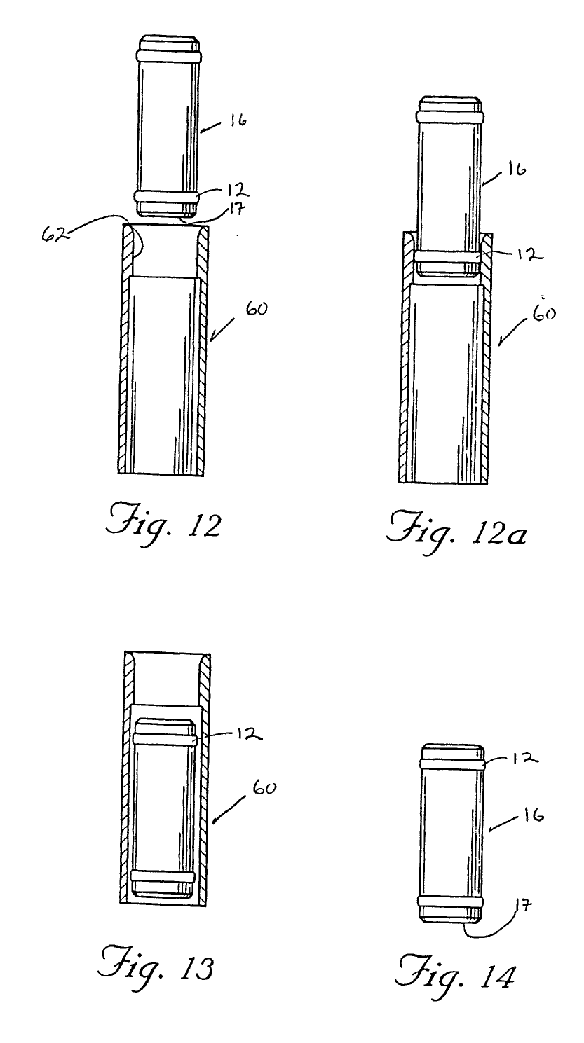

In the preferred embodiment, it is recommended that the banding procedure include a final sizing step, as illustrated in FIGS. 12 and 13. This step obviates the tolerance stack up that occurs during manufacturing of the apertured disc 11 and cylindrical object or solenoid plunger 16. After the band 12 is snapped into place in the pre-formed groove 14 by the expanding diameter pushing tool 10, as discussed above, the solenoid plunger 16 and its band 12 are pushed through a sizing tool 60 in a direction opposite the motion of the initial banding. The sizing tool 60 includes a large radiused lead-in precision sizing area 62 having a polished surface. A lubricant such as WD-40 may be used to facilitate the downward movement. As the solenoid plunger 16 is pushed through the initial lead-in area 62, the installed band 12 is compressed to its final configuration. The solenoid plunger 16 is pushed longitudinally through the sizing tool 60 until the banded area passes the lead-in precision sizing area 62. The remainder of the length of the sizing tool 60 has a diameter greater than that of the banded solenoid plunger 16, thus allowing the finished solenoid plunger 16 to readily pass through without the application of further longitudinal force. If the solenoid plunger 16 or other cylindrical object requires more than one wear band 12, the procedure described above is repeated.

The alternate embodiment of the pushing tool 10a and mandrel 48a combination previously described with reference to FIGS. 5 and 5a, is to be used manually and includes a multi-fingered pushing tool 10a. This tool 10a comprises an integrally formed member defined by a series of circumferentially spaced fingers 8. Each of the fingers 8 is arranged to be compressed inwardly against the bias of a garter or band 7. The size of the band 7 is chosen to compress the distal end 8a of the fingers 8 to form and install the wear band 12 within an encircling pre-formed groove 14 of a cylindrical object, such as a solenoid plunger 16, by means of manual force.

The above-described embodiments of this invention are merely descriptive of its principles and are not to be limited. The scope of this invention instead shall be determined from the scope of the following claims, including their equivalents.

What is claimed is:

1. A cylindrical object including an encircling undercut groove and a seamless band seated within said groove, said band being fabricated from a material capable of being initially formed to an apertured disc-like configuration and subsequently being transformed to an annular continuous band.

2. The cylindrical object of claim 1 wherein said continuous band has a height approximately the longitudinal length of said groove and a thickness slightly greater than the depth of said groove.

3. A unitary solenoid plunger including at least one encircling undercut groove and a seamless band seated within said groove, said band being fabricated from a material capable of being initially formed to an apertured disc-like configuration and subsequently being transformed to an annular continuous band.

4. The unitary solenoid plunger of claim 3, wherein said continuous band has a height approximately the longitudinal length of said groove and a thickness slightly greater than the depth of said groove.

5. A method of making a cylindrical object including a seamless, annular, wear-resistant band, said method comprising the steps of:
providing a pre-formed cylinder;
a providing a conical mandrel;
positioning one end of said cylinder adjacent to and in axial alignment with said mandrel;
providing an annular, relatively flat disc of wear-resistant material and defining a central opening in said disc;
seating said disc on said mandrel;
axially moving said disc over said mandrel whereby said disc is transformed into a continuous annular band; and
continuing said axial movement until said annular band is seated on said cylindrical object.

6. A method of making a cylindrical object including a seamless annular wear resistant band, said method comprising the steps of:
providing a pre-formed cylinder;
providing a truncated conical mandrel;
positioning one end of said cylinder adjacent to and in axial alignment with said mandrel;
providing an annular, relatively flat disc of wear-resistant material and defining a central opening in said disc;
seating said disc with its central opening on said mandrel;
providing a forming tool having a bore for slideably receiving said mandrel, said forming tool having an end in mating relationship with said disc and arranged for slideable axial movement relative to said mandrel;
axially moving said cylinder and mated mandrel relative to said forming tool to contact and to force said disc towards said mandrel whereby said disc is transformed into a continuous annular band; and
continuing said axial movement until said annular band is seated on said cylindrical object.

7. The method of claim 6 including the steps of providing said pre-formed cylinder with an undercut annular encircling groove and seating said annular band in said annular groove.

8. The method of claim 6 including the step of providing said mandrel with a constricted end portion and a distended end portion.

9. The method of claim 6 further providing the step of radially sizing said annular band relative to the diameter of said cylindrical object.

10. An apparatus for forming and installing a seamless, annular, wear-resistant band on a cylindrical object, said apparatus comprising;
a conical mandrel,
said conical mandrel including one end thereof having a distended diameter,
said distended diameter being substantially equivalent to the diameter of
said cylindrical object.

11. An apparatus for manufacturing a cylindrical object having a undercut encircling groove and seating within said groove a seamless, annular, wear-resistant band derived from a relatively flat annular disc, said apparatus comprising:
a supporting base;
an upright pin supported by said base;
a flanged return core having a re-entrant bore arranged to be received by said upright pin;
a coaxial biasing spring supported at opposite ends by the flange of said return core and said supporting base;
a truncated conical mandrel;
an expanding diameter support tool engageable with said mandrel;
said mandrel and said expanding diameter support tool being arranged to receive and support the inner diameter of said relatively flat disc therebetween;
said expanding diameter tool including a plurality of radially spaced band pushers, said band pushers each being slideably retained within radially spaced opening formed in said expanding diameter tool and including pusher spring biasing means for normally forcing said pushers inwardly towards the center of said expanding diameter tool, whereby pressure exerted against said supporting base will be transferred toward said return core via the bias of said coaxial biasing spring and against said disc.

12. The apparatus of claim 11 wherein said mandrel includes one end thereof having a constricted diameter and the opposite end thereof having a relatively distended diameter, the distended diameter being substantially equivalent to the diameter of said cylindrical object.

13. The apparatus of claim 12 wherein said expanding diameter support tool includes an inner diameter substantially equivalent to the constricted diameter of said mandrel and engageable therewith.

14. A method of making a cylindrical object including a seamless annular wear resistant band, said method comprising the steps of:
providing a pre-formed cylinder having an undercut annular encircling groove;
providing a truncated conical mandrel having a constricted end portion and a distended end portion;
positioning one end of said cylinder adjacent to and in axial alignment with said distended end portion of said mandrel;
providing an annular, relatively flat disc of wear-resistant material and defining a central opening in said disc;
seating said disc with its central opening on the constricted end of said mandrel;
providing a forming tool having a bore for slideably receiving said mandrel, said forming tool having an end in mating relationship with said disc and arranged for slideable axial movement relative to said mandrel;
axially moving said cylinder and mated mandrel relative to said forming tool to contact and to force said disc towards the distended end of said mandrel whereby said disc is transformed into a continuous annular band; and
continuing said axial movement until said annular band is seated in said undercut annular groove.
